(19) United States
(12) Patent Application Publication
(10) Pub. No.: US 2011/0220207 A1
(43) Pub. Date: Sep. 15, 2011

(54) SOLENOID GAS METER MOUNTING BRACKET VALVE

(76) Inventor: RAYMOND A. BRONNER, Agawam, MA (US)

(21) Appl. No.: 13/043,789

(22) Filed: Mar. 9, 2011

Related U.S. Application Data
(60) Provisional application No. 61/311,836, filed on Mar. 9, 2010.

(51) Int. Cl. F17D 3/00; F16K 31/02

(52) U.S. Cl. 137/1; 251/129.15

(57) ABSTRACT

A solenoid gas meter mounting bracket valve may be used to shut down the flow of fuel, such as natural gas, to a building. The solenoid valve may be incorporated with the gas meter bracket, as a single unit. This configuration may be safer and more secure than a separate valve, which may be damaged when installed at the exterior of the building. The solenoid gas meter mounting bracket valve may not only secure the gas meter, for example, but may also be the solenoid valve for controlling the fuel flow. The solenoid valve may be closed from signals received from various detectors located, for example, in the structure and in the ground, do detect carbon monoxide, carbon dioxide, radon, air quality, and the like.

### CROSS-REFERENCE TO RELATED APPLICATIONS

This application claims the benefit of priority of U.S. Provisional patent application No. 61/311,836, filed Mar. 9, 2010, the contents of which are herein incorporated by reference.

### BACKGROUND OF THE INVENTION

The present invention relates to flow control valves and, more particularly, to solenoid valve that may be part of a gas meter mounting bracket.

Current gas detection systems may detect a gas leak or apparatus malfunction (such as a gas furnace malfunction that may emit carbon monoxide into the air). These systems, however, may not eliminate the source of the gas leak. Other systems currently in use may detect certain events, such as seismic events or fires inside a structure, and direct a valve to turn off gas flow leading to the building. These valves, however, are often disposed on a gas line as it enters the building, on the exterior thereof. The valve may be damaged due to, for example, snow or ice sliding off the roof of the building.

As can be seen, there is a need for a valve for shutting off the flow of fuel, such as natural gas, that may be protected from accidental damage.

### SUMMARY OF THE INVENTION

In one aspect of the present invention, a system for stopping the flow of a fuel comprises a solenoid valve adapted to close a passageway of the fuel; a mounting bracket formed integrally with the solenoid valve; and one or more detectors adapted to detect a situation requiring the fuel to be stopped send a signal to the solenoid valve to close.

In another aspect of the present invention, a method for controlling the flow of fuel to a structure comprises detecting a situation requiring the fuel to be stopped; and sending a signal to a solenoid valve to close when the situation is detected, wherein the solenoid valve is integral with a mounting bracket.

These and other features, aspects and advantages of the present invention will become better understood with reference to the following drawings, description and claims.

### BRIEF DESCRIPTION OF THE DRAWINGS

FIG. 1 is a schematic view of a solenoid gas meter mounting bracket valve installed in a building, according to an exemplary embodiment of the present invention;

FIG. 2 is a flow chart describing use of the solenoid gas meter mounting bracket valve of FIG. 1;

FIG. 3 is a plan view of the solenoid gas meter mounting bracket valve of FIG. 1;

FIG. 4 is a plan view of a solenoid gas meter mounting bracket valve installed on an oil line, according to an alternate embodiment of the present invention;

FIG. 5 is a plan view of a solenoid gas meter mounting bracket valve installed on a regulated gas line, according to an alternate embodiment of the present invention; and

FIG. 6 is a side view of a solenoid gas meter mounting bracket valve installed on a propane tank outlet, according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a solenoid gas meter mounting bracket valve that may be used to shut down the flow of fuel, such as natural gas, to a building. The solenoid valve may be incorporated with the gas meter bracket, as a single unit. This configuration may be safer and more secure than a separate valve, which may be damaged when installed at the exterior of the building. The solenoid gas meter mounting bracket valve may not only secure the gas meter, for example, but may also be the solenoid valve for controlling the fuel flow. The solenoid valve may be closed from signals received from various detectors located, for example, in the structure and in the ground, do detect carbon monoxide, carbon dioxide, radon, air quality, and the like.

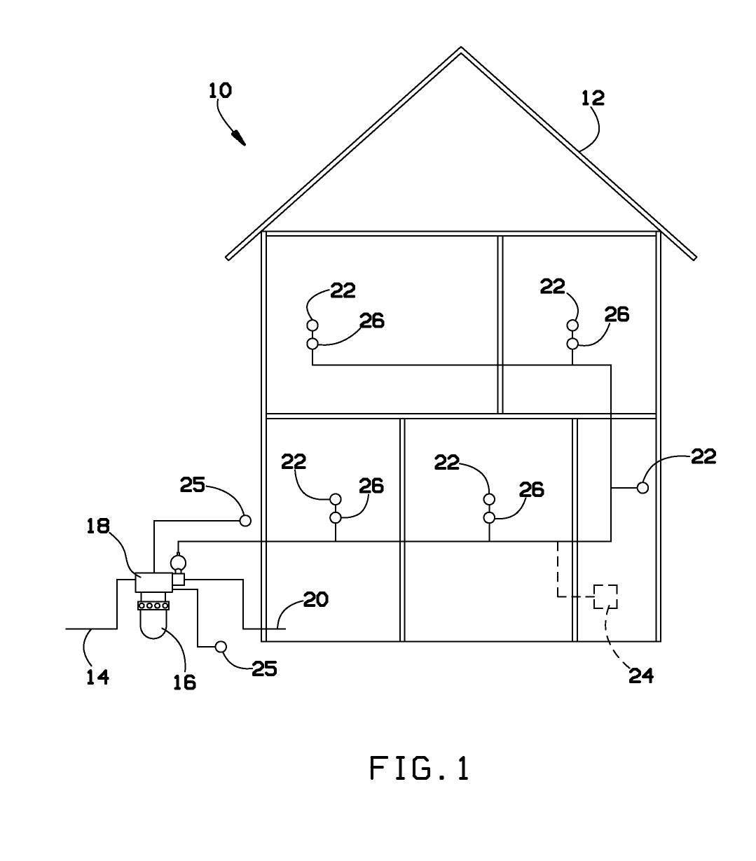

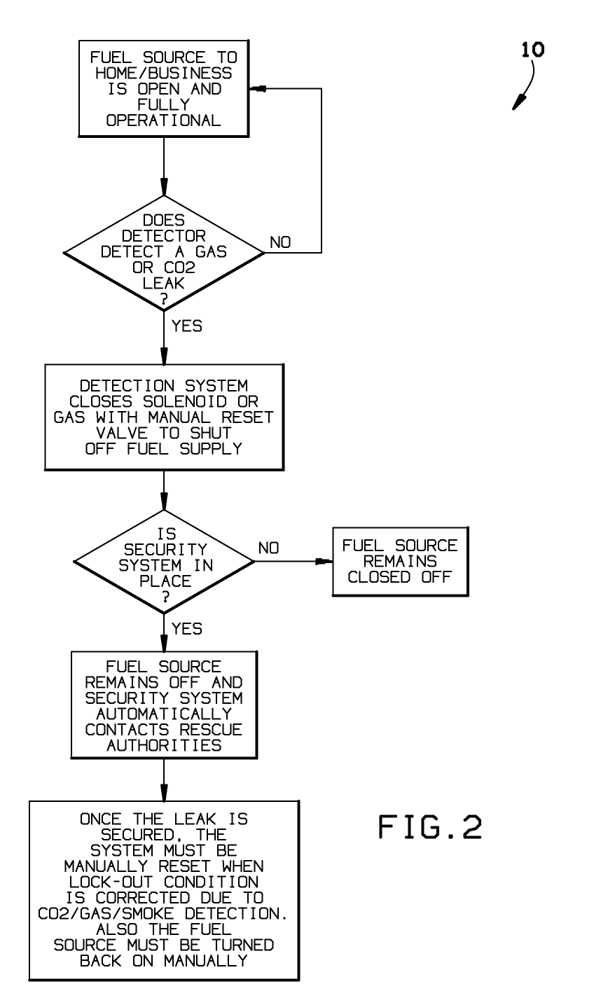

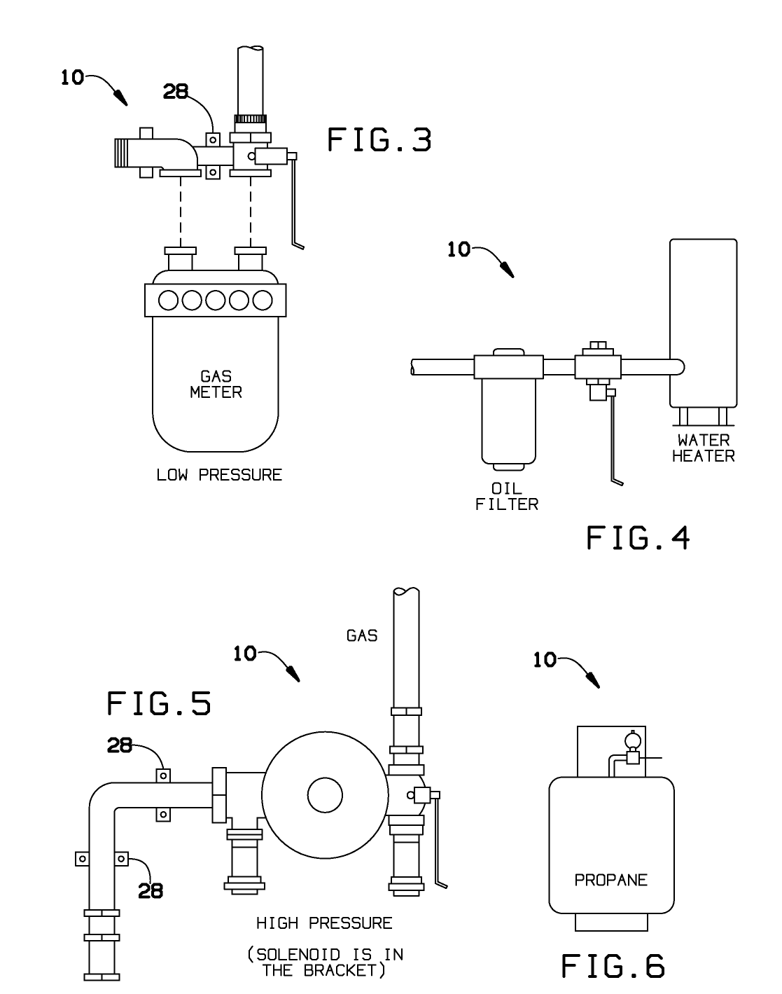

Referring now to FIGS. 1 through 3, a gas regulation system 10 may include solenoid gas meter mounting bracket valve 18 having a solenoid valve and a mounting bracket as a single unit. The mounting bracket may be secured to a structure 12 with one or more hangers 28 or may be secured in the ground. The solenoid gas meter mounting bracket valve 18 may be disposed downstream of a gas meter 16. For example, a main gas line 14 may connect to the gas meter 16. The solenoid gas meter mounting bracket valve 18 may be placed at the outlet of the gas meter 16. A structure gas line 20 may deliver gas to the structure 12. In some embodiments, the solenoid gas meter mounting bracket valve 10 may be placed at the inlet of the gas meter.

Various detectors 22, 26 may be disposed within the structure 12. For example, the detector 22 may detect gas, such as natural gas, carbon monoxide, or the like. The detector 26 may detect radon, carbon dioxide, oxygen levels and other air quality indicators. In new, well insulated homes, inside air quality may be important since air may not readily “leak” into the home from the exterior. The detectors 22, 26 may detect for air quality as well as dangerous compounds (such as carbon monoxide) in the air. When the detectors 22, 26 detect a dangerous situation inside the structure 12, a signal may be sent to the solenoid gas meter mounting bracket valve 18 to close, thus stopping the leak of poisonous gas, preventing explosion, or continuing the degradation of air quality. For example, a gas fireplace may deplete the oxygen from a well-insulated home, which one of the detectors 22, 26 may detect, turning off the flow of natural gas and, thus, stopping the gas fireplace from depleting the oxygen content of the home.

A security notification system 24 may be part of the system 10. In some embodiments, the security notification system 24 may cause emergency personnel to be dispatched to the structure 12 should the detectors 22, 26 detect a dangerous situation such as low oxygen levels, high carbon dioxide levels, high carbon monoxide levels, natural gas leaks or the like. The security notification system may be configured to notify emergency personnel not only when the detectors 22, 26 detect a dangerous situation, but also whenever the solenoid gas meter mounting bracket valve 18 is closed.

In addition to detectors 22, 26 inside of the structure 12, detectors 25 may be disposed outside of the structure 12. For example, one outside detector 25 may be placed near the gas meter 16 to detect leaks at or near the meter. Another outside detector 25 may be placed in the ground at or near the gas meter 16 to detect leaks from the main gas line 14. In other embodiments, outside detectors 25 may be placed along the main gas line 14, between structures, to detect gas leaks in the main gas line 14. As buried gas lines age, detection of slow leaks may help prevent larger leaks, fires or explosions.

While FIG. 1 shows a wired system, with connections between each of the detectors 22, 25, 26, the detectors 22, 25, 26 may be wireless detectors. The wireless detectors may transmit a signal to a receiver (not shown) at the solenoid gas meter mounting bracket valve 18. The wireless detectors, as well as the wired detectors, may be powered by, for example, a battery or the power of the structure 12 (such as 110 volts alternating current).

Referring to FIG. 4, the solenoid valve may be used to control the flow of oil, for example. Similar to the embodiment of FIGS. 1-3, the solenoid valve may include a mounting bracket (not shown) for securing the fuel line and the solenoid valve.

Referring to FIG. 5, the solenoid valve may be placed either downstream (not shown) or upstream of a gas pressure regulator. For example, when a meter is not present, the gas pressure regulator may control the gas pressure before it enters a structure. The solenoid valve may, as described above, be integral with a bracket that secures the pressure regulator. Such a bracket system may include one or more hangers 28, as shown in FIG. 5.

Referring to FIG. 6, the solenoid valve may be placed at the outlet of a propane tank. The solenoid valve may be part of a bracket system (not shown) that attaches the outlet of the propane tank to safety ring portion of the propane tank.

It should be understood, of course, that the foregoing relates to exemplary embodiments of the invention and that modifications may be made without departing from the spirit and scope of the invention as set forth in the following claims.

What is claimed is:

1. A system for stopping the flow of a fuel, the system comprising:
a solenoid valve adapted to close a passageway of the fuel;
a mounting bracket formed integrally with the solenoid valve; and
one or more detectors adapted to detect a situation requiring the fuel to be stopped and send a signal to the solenoid valve to close.

2. The system of claim 1, wherein the fuel is natural gas.

3. The system of claim 1, wherein the solenoid valve and mounting bracket secure a gas meter.

4. The system of claim 1, further comprising one or more hangers adapted to secure the mounting bracket to a structure.

5. The system of claim 1, wherein the detectors are adapted to detect at least one of carbon monoxide, carbon dioxide, oxygen, radon and natural gas.

6. The system of claim 1, further comprising a security notification system adapted to send a notification signal to emergency personnel when the situation requiring fuel to be stopped is detected.

7. The system of claim 1, wherein at least one detector is disposed inside a structure.

8. The system of claim 1, wherein at least one detector is disposed outside of the structure.

9. A method for controlling the flow of fuel to a structure, comprising:
detecting a situation requiring the fuel to be stopped; and
sending a signal to a solenoid valve to close when the situation is detected, wherein
the solenoid valve is integral with a mounting bracket.

10. The method of claim 9, wherein the fuel is natural gas and the mounting bracket is adapted to secure a gas meter.
